(19) United States
(12) Patent Application Publication
(10) Pub. No.: US 2008/0310639 A1
(43) Pub. Date: Dec. 18, 2008

(54) COMMUNICATION APPARATUS, COMMUNICATION SYSTEM, AND COMMUNICATION METHOD

(75) Inventors: Mitsuru Kanda, Tokyo (JP); Yasuyuki Kozakai, Kawasaki-shi (JP); Kohji Saiki, Tokyo (JP); Masashi Tsuji, Kawasaki-shi (JP)

Correspondence Address: Charles N.J. Ruggiero, Esq.;Ohlandt , Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/021,956

(22) Filed: Jan. 29, 2008

(30) Foreign Application Priority Data
Jun. 18, 2007 (JP) 2007-160421

(51) Int. Cl. H04L 9/00

(52) U.S. Cl. 380/283

(57) ABSTRACT

A communication apparatus stores, in a memory, secret data shared with a first terminal, transmits a first connection request message to the first terminal, receives (a) a transfer instruction message which is transmitted from the first terminal in response to the first connection request message, includes address information of a second terminal, and instructs transfer of a connection request to the second terminal, and (b) an encrypted message which is encrypted by using a public key of the second terminal or a shared key shared between the first terminal and the second terminal, transmits the encrypted message together with a second connection request message whose destination is the address information, receives a response message to the second connection request message and a decryption result of the encrypted message, and starts, when the decryption result equals the secret data, a communication with the second terminal.

### CROSS-REFERENCE TO RELATED APPLICATIONS

This application is based upon and claims the benefit of priority from prior Japanese Patent Application No. 2007-160421, filed Jun. 18, 2007, the entire contents of which are incorporated herein by reference.

### BACKGROUND OF THE INVENTION

1. Field of the Invention

The invention relates to a communication apparatus which uses an SIP (Session Initiation Protocol) as a call signaling protocol used for IP phones on a network such as the Internet, intranet, and the like.

2. Description of the Related Art

An SIP is a protocol for a session layer which is used for Internet phones and the like and is required to establish a session between two or more terminals (for example, see reference 1: IETF RFC3261, SIP: Session Initiation Protocol. J. Rosenberg, H. Schulzrinne, G Camarillo, A. Johnston, J. Peterson, R. Sparks, M. Handley, E. Schooler. June 2002.).

Conventionally, upon reception of information (SIP URI or the like) of a transfer destination from a transfer instruction node, when a connection request source node (transfer instruction reception node) attempts to establish a connection to a transfer destination node based on that information, it is difficult to confirm (authenticate) whether or not that transfer destination node is, in fact, a node intended by the transfer instruction node. This means that node information (address information) indicating the transfer destination received from the transfer instruction node may have changed. Such change is likely to occur irrespective of the presence/absence of ill intent.

For example, the IP address of the transfer destination node changes when an IP address lease time based on the DHCP (Dynamic host configuration protocol) has elapsed or when the valid lifetime of an IPv6 privacy address has expired. Also, the IP address is often forged by hijacking the DNS (Domain name system).

In this manner, irrespective of whether or not the address information of the transfer destination instructed from the transfer instruction node may have changed, conventionally, the transfer instruction reception node cannot confirm whether or not a transfer destination corresponding to the address information notified from the transfer instruction node is the one intended by the transfer instruction node.

### BRIEF SUMMARY OF THE INVENTION

A communication system including a first terminal, a second terminal, and a third terminal which are connected to a network.

(1) The First Terminal

stores, in a first secret data memory, secret data shared with the second terminal; and

transmits a first connection request message to the second terminal.

(2) The Second Terminal

stores, in a first encryption key memory, a public key of the third terminal or a shared key shared with the third terminal;

stores, in a second secret data memory, the secret data shared with the first terminal;

receives the connection request message from the first terminal;

encrypts the secret data by using one of the public key and the shared key stored in the first encryption key memory, to generate an encrypted message; and

transmits, to the first terminal, the encrypted message together with a transfer instruction message which includes address information of the third terminal and instructs transfer of a connection request to the third terminal.

(3) The First Terminal

receives the transfer instruction message and the encrypted message; and

transmits the encrypted message together with a second connection request message whose destination is the address information in the transfer instruction message received.

(4) The Third Terminal

stores, in a second encryption key memory, a private key corresponding to the public key or the shared key;

receives the second connection request message and the encrypted message transmitted;

decrypts the encrypted message received by using the private key or the shared key stored in the second encryption key memory; and

transmits, to the first terminal, a response message to the second connection request and a decryption result of the encrypted message.

(5) The First Terminal

receives the response message and the decryption result; and

compares the decryption result with the secret data stored in the first secret data memory, and starts, when the decryption result equals the secret data, a communication with the third terminal.

### BRIEF DESCRIPTION OF THE SEVERAL VIEWS OF THE DRAWING

FIG. 1 is a view for explaining a schematic sequence for transferring a call request from SIP terminal A to SIP terminal C;

FIG. 2 is a block diagram showing an example of the arrangement of SIP terminals;

FIG. 3 is a sequence chart for explaining a practical example of the first transfer sequence; and

FIG. 4 is a sequence chart for explaining a practical example of the first transfer sequence.

### DETAILED DESCRIPTION OF THE INVENTION

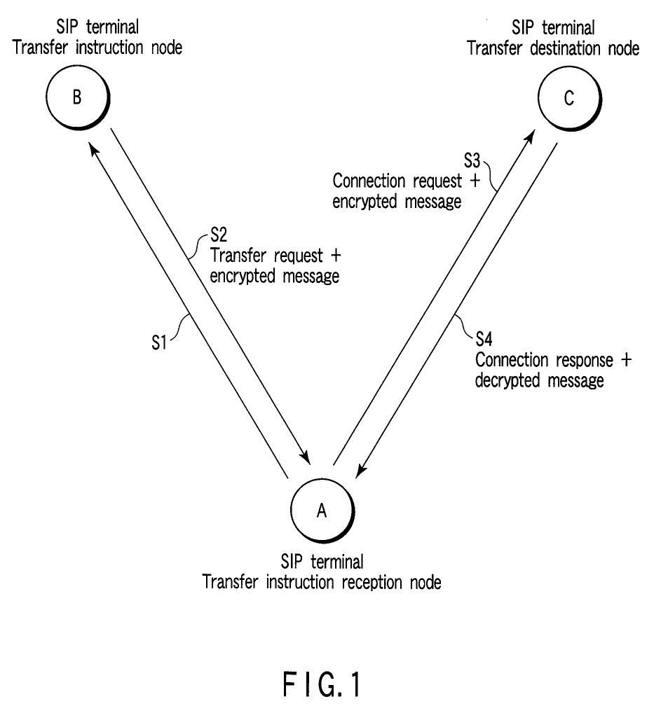

As shown in FIG. 1, SIP (Session Initiation Protocol) compatible terminals A to C are connected to a network (NW) such as the Internet, intranet, or the like. These terminals A to C will be referred to as SIP terminals A to C hereinafter.

A case will be examined below wherein when SIP terminal A calls SIP terminal B (to issue a connection request), SIP terminal B issues a transfer instruction to SIP terminal A to transfer a call request (connection request) from SIP terminal A to SIP terminal C, as shown in FIG. 1. Note that the SIP terminal as a communication partner is designated using address information such as an IP address or SIP URI (Uniform Resource Identifier).

In this embodiment, when SIP terminal B transfers a connection request from SIP terminal A to SIP terminal C in this way, SIP terminal A as a connection request source (transfer instruction reception node) confirms whether or not a transfer destination is SIP terminal C as a transfer destination node intended by SIP terminal B as a transfer instruction node.

For this purpose, SIP terminal B pre-stores a public key of SIP terminal C. SIP terminals A and B share secret data between themselves.

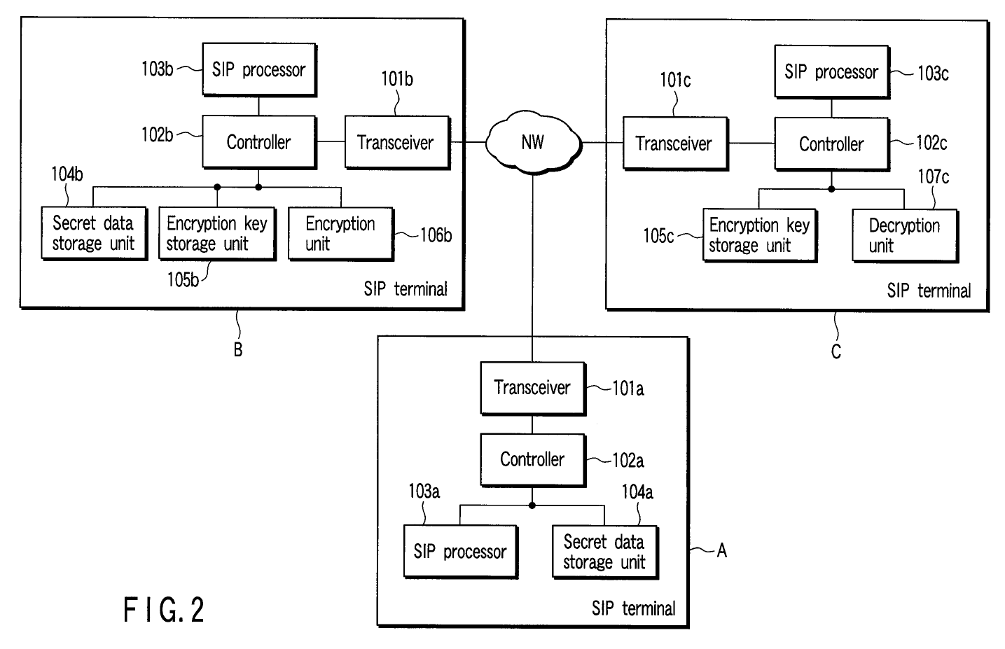

FIG. 2 shows an example of the arrangement of principal parts of SIP terminals A, B, and C according to this embodiment. Referring to FIG. 2, SIP terminal A includes a transceiver 101a, controller 102a, SIP processor 103a, and secret data storage unit 104a. The transceiver 101a exchanges messages and the like with other terminals via the network. The SIP processor 103a executes processing required to implement various SIP functions. That is, the unit 103a generates SIP messages (a request message, response message, and the like) to execute start/change/end sequences of a session. The secret data storage unit 104a stores given secret data between SIP terminals A and B in this case. The controller 102a performs overall control of SIP terminal.

SIP terminal B includes an encryption key storage unit 105b and encryption unit 106b in addition to a transceiver 101b, controller 102b, SIP processor 103b, and secret data storage unit 104b. The transceiver 101b, controller 102b, SIP processor 103b, and secret data storage unit 104b are the same as the transceiver 101a, controller 102a, SIP processor 103a, and secret data storage unit 104a of SIP terminal A. The encryption key storage unit 105b stores a public key of, e.g., SIP terminal C. The encryption unit 106b encrypts the secret data using an encryption key (the public key of SIP terminal C in this case) stored in the encryption key storage unit 105b, as will be described later.

SIP terminal C includes an encryption key storage unit 105c and decryption unit 107c in addition to a transceiver 101c, controller 102c, and SIP processor 103c. The transceiver 101c, controller 102c, and SIP processor 103c are the same as the transceiver 101a, controller 102a, and SIP processor 103a of SIP terminal A. The encryption key storage unit 105c stores, e.g., a private key of SIP terminal C in this case. The decryption unit 107c decrypts an encrypted message sent from SIP terminal A using an encryption key (the private key of SIP terminal C in this case) stored in the encryption key storage unit 105c.

A schematic sequence for transferring a connection request from SIP terminal A to SIP terminal C will be described below with reference to FIG. 1.

In step S1, the SIP processor 103a of SIP terminal A generates a connection request message used to call for SIP terminal B, i.e., an SIP INVITE request. This SIP INVITE request is transmitted from the transceiver 101a.

In step S2, the transceiver 101b of SIP terminal B receives the SIP INVITE request transmitted from SIP terminal A. In response to this request, the SIP processor 103b of SIP terminal B generates a transfer instruction message which includes the address information of SIP terminal C and instructs SIP terminal A to transfer the connection request to SIP terminal C. As this transfer instruction message, an SIP REFER request, 302 Moved Temporarily response, and the like may be used. On the other hand, the encryption unit 106b of SIP terminal B encrypts the secret data (information unknown to SIP terminal C), which is stored in the secret data storage unit 104b and is shared with SIP terminal A, using the public key of SIP terminal C, which is stored in the encryption key storage unit 105b, thereby generating an encrypted message. The controller 102b appends this encrypted message to the transfer instruction message generated by the SIP processor 103b, and transmits that message to SIP terminal A from the transceiver 101b. Note that the secret data may be a time at which SIP terminal A issued the connection request to SIP terminal B (e.g., a time stamp recorded in the connection request message transmitted from SIP terminal A to SIP terminal B in step S1).

In step S3, in SIP terminal A which receives the transfer instruction message by the transceiver 101a, the SIP processor 103a generates a connection request message (SIP INVITE request) to be transmitted to a transfer destination node based on the address information of the transfer destination included in the Contact header in the transfer instruction message. The controller 102a transmits this connection request message together with the encrypted message received from SIP terminal B to the transfer destination node from the transceiver 101a.

In step S4, in SIP terminal C as the transfer destination node, which receives the connection request message from SIP terminal A, the SIP processor 103c generates a response message to the connection request message. The controller 102c calls the decryption unit 107c. The decryption unit 107c decrypts the encrypted message appended to the connection request message using the own private key stored in the encryption key storage unit 105c, and sends the decrypted message to the controller 102c. The controller 102c appends the decrypted message to the connection response message to SIP terminal A generated by the SIP processor 103c, and returns that message to SIP terminal A from the transceiver 101c.

Upon reception of the connection response message from SIP terminal C, the controller 102a of SIP terminal A verifies the decrypted message appended to the connection response message. That is, the controller 102a compares the decrypted message with the secret data shared between SIP terminals B and A (stored in the secret data storage unit 104a). If the decrypted message equals the secret data, the controller 102a determines that SIP terminal C is the transfer destination intended by SIP terminal B. After that, SIP terminal A starts an actual communication with SIP terminal C.

The match between the decryption result sent from SIP terminal C, and the secret data between SIP terminals A and B, means that SIP terminal C has a private key corresponding to the public key of SIP terminal B. That is, the match between the decryption result sent from SIP terminal C, and the secret data, is nothing but the proof that SIP terminal C is the transfer destination intended by SIP terminal B.

In the above description, the secret data is encrypted using the public key method. That is, the encryption key storage unit 105b of SIP terminal B stores the public key of SIP terminal C, and the encryption key storage unit 105c of SIP terminal C stores the private key of SIP terminal C. However, a secret key encryption method may be used in place of the public key method. That is, the secret data is encrypted and decrypted using a shared key (secret key) shared by SIP terminal B as the transfer instruction node and SIP terminal C as the transfer destination node. In this case, the encryption key storage units 105b and 105c of SIP terminals B and C store a shared key shared between SIP terminals B and C. Then, the match between the decryption result sent from SIP terminal C and the secret data between SIP terminals A and B means that SIP terminal C has a shared key shared with SIP terminal B. Hence, as in the aforementioned public key method, the match between the decryption result sent from SIP terminal C and the secret data proves that SIP terminal C is the transfer destination intended by SIP terminal B.

When SIP terminal A as the transfer instruction reception node establishes a connection to SIP terminal C as the transfer destination node, SIP terminal C as the transfer destination node may execute caller authentication of SIP terminal A as the transfer instruction reception node using a “WWW-Authenticate” header in the SIP message (see reference 2: [IETF RFC3261, SIP: Session Initiation Protocol. J. Rosenberg, H. Schulzrinne, G Camarillo, A. Johnston, J. Peterson, R. Sparks, M. Handley, E. Schooler. June 2002.]).

A practical example of the transfer sequence shown in FIG. 1 will be described below. Note that messages which are used in this example and are specified by the SIP will be briefly explained.
INVITE request message: a session entry request
302 Moved temporarily response message: a redirect response which means that a request must be sent to another place
200 OK response message: a response message which informs that a request has succeeded
ACK message: confirmation of a final response to “INVITE”
Refer request message: a message which instructs to transfer a call to another URI
202 Accepted message: a response message which informs that a request has succeeded
Notify message: information transmission of the user
180 Ringing message: a response message which informs that a request is received, and its processing is underway

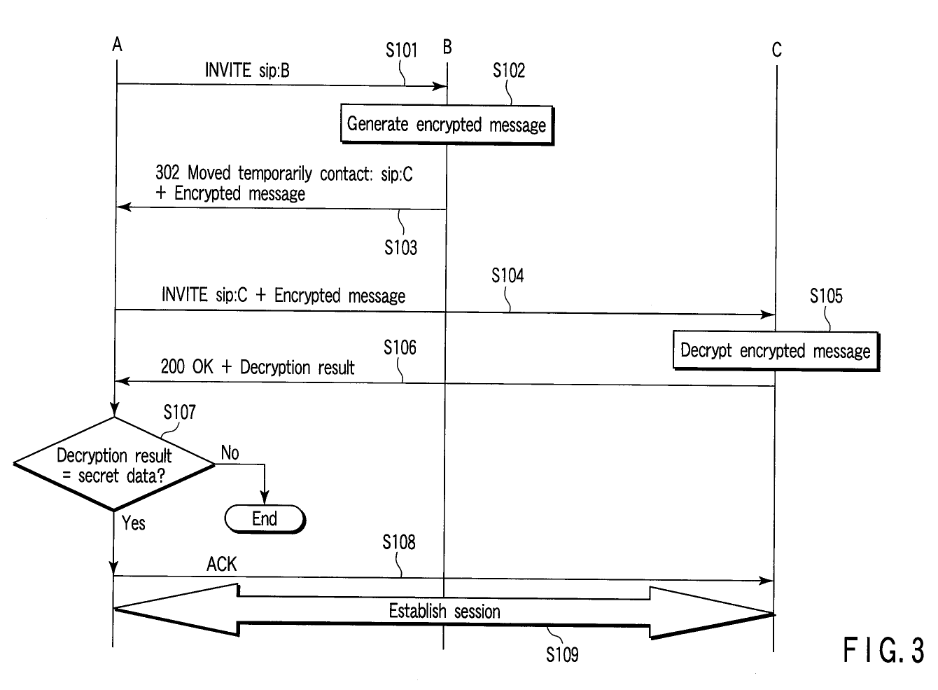

The first practical example of the transfer sequence will be described first with reference to FIG. 3. In SIP terminal A, the SIP processor 103a generates an INVITE request message to call SIP terminal B. The destination of the INVITE request message includes the IP address or SIP URI of SIP terminal B. The transceiver 101a transmits the generated INVITE request message (step S101).

In SIP terminal B which receives the INVITE request message from SIP terminal A, the SIP processor 103b generates a 302 Moved temporarily response message to transfer that request to SIP terminal C. The Contact header in this message includes the IP address or SIP URI of SIP terminal C. On the other hand, the encryption unit 106b generates an encrypted message by encrypting the secret data (information unknown to SIP terminal C), which is stored in the secret data storage unit 104b and is shared with SIP terminal A, using the public key of SIP terminal C, which is stored in the encryption key storage unit 105b (step S102). The controller 102b appends this encrypted message to the 302 Moved temporarily response message generated by the SIP processor 103b, and transmits that message to SIP terminal A from the transceiver 101b (step S103).

Upon reception of the 302 Moved temporarily response message by the transceiver 101a, the SIP processor 103a of SIP terminal A generates an INVITE request message which includes, as a destination, the transfer destination information included in the Contact header in the received message. The controller 102a transmits this INVITE request message to the transfer destination from the transceiver 101a together with the encrypted message received from SIP terminal B (step S104).

Upon reception of the INVITE request message from SIP terminal A, the SIP processor 103c of SIP terminal C as the transfer destination node generates a response message (e.g., 200 OK message) to the request message. The decryption unit 107c decrypts the encrypted message appended to the request message using the private key stored in the encryption key storage unit 105c. The controller 102c appends the decrypted message to the 200 OK message generated by the SIP processor 103c, and returns that message from transceiver 101c to SIP terminal A (step S106).

Upon reception of the 200 OK message from SIP terminal C, the controller 102a of SIP terminal A verifies the decrypted message appended to that response message. If that message matches the secret data (stored in the secret data storage unit 104a) shared between SIP terminals B and A, the controller 102a determines that SIP terminal C is the transfer destination intended by SIP terminal B (step S107), and the process advances to step S108. If the decryption result is different from the secret information (step S107), the process ends.

In step S108, the SIP processor 103a of SIP terminal A generates an ACK message including SIP terminal C as a destination, and transmits it from the transceiver 101a. After that, an actual communication is continued between SIP terminals A and C.

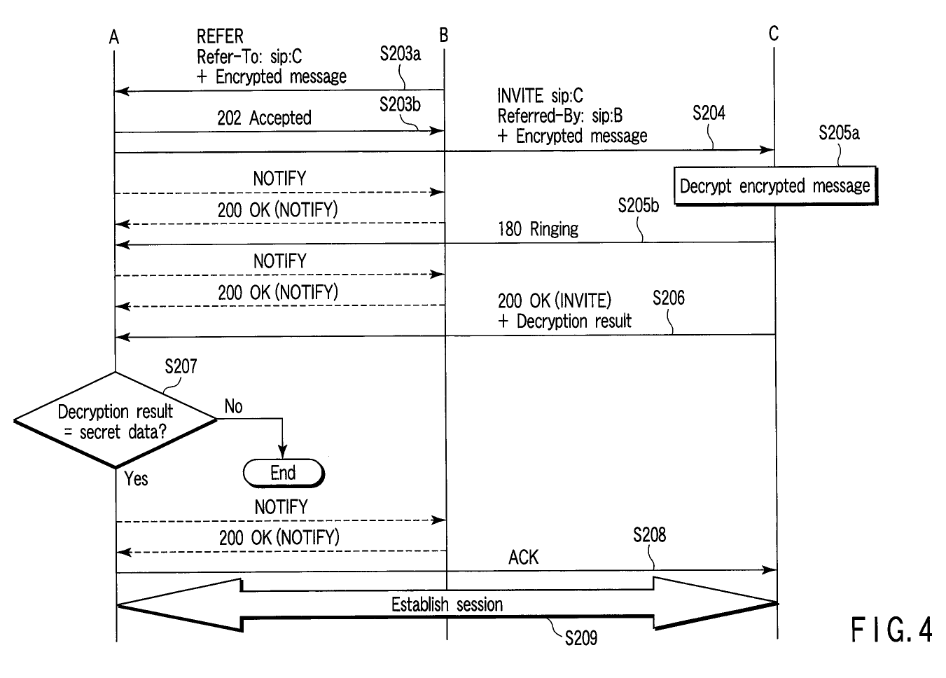

The second practical example of the transfer sequence will be described below with reference to FIG. 4. SIP terminal A transmits an INVITE request message to SIP terminal B to call SIP terminal B, as in, e.g., step S101 in FIG. 3.

Upon reception of the INVITE request message from SIP terminal A, SIP terminal B generates an encrypted message as in step S102 in FIG. 3. On the other hand, the SIP processor 103b generates a Refer-To request message so as to transfer that request to SIP terminal C. The Refer-to header in this message includes the IP address or SIP URI of SIP terminal C as the transfer destination node. The controller 102b appends the encrypted message to the Refer-To request message generated by the SIP processor 103b, and transmits that message from the transceiver 101b to SIP terminal A (step S203a).

Upon reception of the Refer-To request message by the transceiver 101a, the SIP processor 103a of SIP terminal A generates a response message to that request message, i.e., a 202 Accepted message, and the transceiver 101a transmits this response message to SIP terminal B (step S203b).

Furthermore, the SIP processor 103a of SIP terminal A generates an INVITE request message which includes, as a destination, the transfer destination information included in the Refer-to header in the received Refer-to request message. The Referred-By header of this INVITE request message includes the IP address or SIP URI of SIP terminal B. The controller 102a transmits this INVITE request message from the transceiver 101a to the transfer destination together with the encrypted message received from SIP terminal B (step S204).

Upon reception of the INVITE request message from SIP terminal A, the decryption unit 107c of SIP terminal C as the transfer destination node decrypts the encrypted message appended to that request message using the private key stored in the encryption key storage unit 105c (step S205a). At this time, the SIP processor 103c may generate a 180 Ringing message and may transmit it from the transceiver 101c to SIP terminal A (step S205b). Upon completion of the decryption processing of the encrypted message, the SIP processor 103c generates a response message (e.g., 200 OK message) to the INVITE message. The controller 102c appends the decrypted message to the 200 OK message generated by the SIP processor 103c, and returns that message from the transceiver 101c to SIP terminal A (step S206).

Upon reception of the 200 OK message from SIP terminal C, the controller 102a of SIP terminal A verifies the decrypted message appended to the response message. If that message matches the secret data (stored in the secret data storage unit 104a) shared between SIP terminals B and A, the controller 102a determines that SIP terminal C is the transfer destination intended by SIP terminal B (step S207). If the decryption result is different from the secret data (step S207), the process ends.

If the decryption result matches the secret data, the SIP processor 103a of SIP terminal A generates an ACK message including SIP terminal C as a destination, and transmits it from the transceiver 101a (step S208). After that, a communication starts between SIP terminals A and C (step S209).

While SIP terminals A and C are communicating with each other in the processing sequence, SIP terminals A and B exchange a Notify message and its response message (200 OK response message) between them.

As described above, according to the above embodiment, when SIP terminal A transfers a connection request to the transfer destination node upon reception of a transfer request from SIP terminal B, SIP terminal A checks whether or not data of the decryption result sent from the transfer destination node equals the secret data shared between SIP terminals A and B. With this checking process, SIP terminal A can easily confirm without the intervention of a third party that the transfer destination node is a transfer destination intended by SIP terminal B, and that it is a reliable partner for SIP terminal A. That is, the transfer instruction reception node (SIP terminal A) can easily confirm whether or not a transfer destination corresponding to the address information notified by the transfer instruction node (SIP terminal B) is the one intended by the transfer instruction node.

The method of the invention (the processing sequences shown in FIGS. 3 and 4) described in the embodiment of the invention can be stored, as a program that can be executed by a computer, in a recording medium such as a magnetic disc (flexible disc, hard disc, or the like), an optical disc (CD-ROM, DVD, or the like), a semiconductor memory, and the like, and can be distributed.

What is claimed is:

1. A communication apparatus connected to a network, comprising:
a memory to store secret data shared with a first terminal connected to the network;
a first transmission unit configured to transmit a first connection request message to the first terminal;
a first reception unit configured to receive (a) a transfer instruction message which is transmitted from the first terminal in response to the first connection request message, includes address information of a second terminal connected to the network, and instructs transfer of a connection request to the second terminal, and (b) an encrypted message which is encrypted by using a public key of the second terminal or a shared key shared between the first terminal and the second terminal;
a second transmission unit configured to transmit the encrypted message together with a second connection request message whose destination is the address information in the transfer instruction message received by the first reception unit;
a second reception unit configured to receive a response message to the second connection request message and a decryption result of the encrypted message; and
a control unit configured to compare the decryption result with the secret data, and to start, when the decryption result equals the secret data, a communication with the second terminal.

2. The apparatus according to claim 1, wherein the transfer request message is an SIP (Session Initiation Protocol) Moved temporarily response message.

3. The apparatus according to claim 1, wherein the transfer request message is an SIP (Session Initiation Protocol) Refer-to request message.

4. The apparatus according to claim 1, wherein the first connection request message and the second connection request message are SIP (Session Initiation Protocol) INVITE request messages.

5. The apparatus according to claim 1, wherein the secret data is a transmission time of the first connection request message.

6. A communication system including a first terminal, a second terminal, and a third terminal which are connected to a network,
the first terminal comprising:
a first secret data memory to store secret data shared with the second terminal; and
a first transmission unit configured to transmit a first connection request message to the second terminal;
the second terminal comprising:
a first encryption key memory to store a public key of the third terminal or a shared key shared with the third terminal;
a second secret data memory to store the secret data shared with the first terminal;
a first reception unit configured to receive the connection request message from the first terminal;
an encryption unit configured to encrypt the secret data by using the public key or the shared key stored in the first encryption key memory, to generate an encrypted message; and
a second transmission unit configured to transmit, to the first terminal, the encrypted message together with a transfer instruction message which includes address information of the third terminal and instructs transfer of a connection request to the third terminal;
the first terminal further comprising:
a second reception unit configured to receive the transfer instruction message and the encrypted message; and
a third transmission unit configured to transmit the encrypted message together with a second connection request message whose destination is the address information in the transfer instruction message received by the second reception unit,
the third terminal comprising:
a second encryption key memory to store a private key corresponding to the public key or the shared key;
a third reception unit configured to receive the second connection request message and the encrypted message transmitted by the third transmission unit;
a decryption unit configured to decrypt the encrypted message received by using the private key or the shared key stored in the second encryption key memory; and
a fourth transmission unit configured to transmit, to the first terminal, a response message to the second connection request and a decryption result of the encrypted message, and
the first terminal further comprising:
a fourth reception unit configured to receive the response message and the decryption result; and
a control unit configured to compare the decryption result with the secret data stored in the first secret data memory, and to start, when the decryption result equals the secret data, a communication with the third terminal.

7. The system according to claim 6, wherein the transfer request message is an SIP (Session Initiation Protocol) Moved temporarily response message.

8. The system according to claim 6, wherein the transfer request message is an SIP (Session Initiation Protocol) Refer-to request message.

9. The system according to claim 6, wherein the secret data is a time at which the first terminal transmitted the first connection request message.

10. A communication method applied to a communication apparatus connected to a network, including:
storing, in a memory, secret data shared with a first terminal connected to the network;
transmitting a first connection request message to the first terminal;
receiving (a) a transfer instruction message which is transmitted from the first terminal in response to the first connection request message, includes address information of a second terminal connected to the network, and instructs transfer of a connection request to the second terminal, and (b) an encrypted message which is encrypted by using a public key of the second terminal or a shared key shared between the first terminal and the second terminal;
transmitting the encrypted message together with a second connection request message whose destination is the address information in the transfer instruction message received;
receiving a response message to the second connection request message, and a decryption result of the encrypted message;
comparing the decryption result with the secret data; and
starting, when the decryption result equals the secret data, a communication with the second terminal.

11. The method according to claim 10, wherein the transfer request message is an SIP (Session Initiation Protocol) Moved temporarily response message.

12. The method according to claim 10, wherein the transfer request message is an SIP (Session Initiation Protocol) Refer-to request message.

13. The method according to claim 10, wherein the first connection request message and the second connection request message are SIP (Session Initiation Protocol) INVITE request messages.

14. The method according to claim 10, wherein the secret data is a transmission time of the first connection request message.

15. A computer readable storage medium storing instructions of a computer program which when executed by a computer results in performance of steps comprising:
storing, in a memory, secret data shared with a first terminal connected to the network;
transmitting a first connection request message to the first terminal;
receiving (a) a transfer instruction message, which is transmitted from the first terminal in response to the first connection request message, includes address information of a second terminal connected to the network, and instructs transfer of a connection request to the second terminal, and (b) an encrypted message which is encrypted by using a public key of the second terminal or a shared key shared between the first terminal and the second terminal;
transmitting the encrypted message together with a second connection request message whose destination is the address information in the transfer instruction message received;
receiving a response message to the second connection request message and a decryption result of the encrypted message;
comparing the decryption result with the secret data; and
starting, when the decryption result equals the secret data, a communication with the second terminal.
